(19) United States
(12) Patent Application Publication
(10) Pub. No.: US 2014/0261882 A1
(43) Pub. Date: Sep. 18, 2014

(54) FUEL DISPENSERS

(71) Applicant: BPC Acquisition Company, Spring Lake, MI (US)

(72) Inventors: Sarah Ann Lambrix, Grand Haven, MI (US); Chad Robert Paffhausen, Spring Lake, MI (US); Adam Kenneth Simon, Norton Shores, MI (US); Jonathan M. Rathbun, Belmont, MI (US)

(73) Assignee: BPC Acquisition Company, Spring Lake, MI (US)

(21) Appl. No.: 14/211,393

(22) Filed: Mar. 14, 2014

Related U.S. Application Data
(60) Provisional application No. 61/793,256, filed on Mar. 15, 2013.

(51) Int. Cl. B67D 7/04; B67D 7/06

(52) U.S. Cl. CPC B67D 7/04; B67D 7/06
USPC 141/94

(57) ABSTRACT

Fuel dispensers are provided that include a controller that controls sales transactions, The controller allows a user to dispense more than one fuel type in a single sales transaction. The types of fuel may include various combinations and subcombinations of liquid natural gas (LNG), compressed natural gas (CNG), gasoline, diesel fuel, and diesel exhaust fluid (DEF). A display on the dispensers may be used to display training images. The dispensers may use a novel communication protocol for communicating with a control console of a fuel farm.

### CROSS-REFERENCE TO RELATED APPLICATION

This application claims priority to and the benefit under 35 U.S.C. §119(e) of U.S. Provisional Patent Application No. 61/793,256, filed on Mar. 15, 2013, entitled “FUEL DISPENSERS,” by Sarah Ann Lambrix et al., the entire disclosure of which is incorporated herein by reference.

### BACKGROUND OF THE INVENTION

The present invention generally relates to dispensers for dispensing fuels and other fluids to vehicles, including natural gas such as liquid natural gas (LNG), compressed natural gas (CNG), gasoline, diesel fuel, and diesel exhaust fluid (DEF), such as urea.

### SUMMARY OF THE INVENTION

According to an embodiment of the present invention, a natural gas dispensing system is provided comprising: a natural gas farm; a natural gas dispenser coupled to the natural gas farm to receive natural gas; a control console for controlling operations of the natural gas farm; and a dispenser controller for controlling the natural gas dispenser. The dispenser controller and the control console are configured to communicate over a network utilizing a defined message protocol defining a packet format, the packet format comprising a sync field, an address field, a command field, data length field, data field, and a checksum field. The sync field may include a specified sync character, and wherein, upon receiving the sync character, the dispenser controller dumps any previously received characters and prepares to receive a new command from the control console. The address field may include an address that identifies the dispenser controller as an intended recipient of a message on the network. The command field may be used to identify a specific dispenser command. The command field may include at least one of the following dispenser commands: station status, request dispenser status, request sale status, request dispenser totals, and request error status. The station status command may be a command sent from the control console to inform the dispenser controller of a status of a fuel supply. The request dispenser status command may be a command sent from the control console to cause the dispenser controller to respond with complete status information for the natural gas dispenser. The complete status information included in a response message from the dispenser controller may include at least one of: dispenser status, fuel status and fuel level percentage of whatever types and grades of fuel are dispensed from the natural gas dispenser, ambient temperature, product temperature, product pressure, flow rate, and density. The dispenser status may include at least one of: dispenser error, meter error, authorized, product request, saturated/unsaturated, recirculating, sale complete, fill valve status, recirculation valve status, vent valve status, and fuel available. The fuel status may include at least one of: detector not found, detector error, calibration needed, replace sensor, low alarm active, and high alarm active. The request sale status command may be a command sent from the control console to cause the dispenser controller to respond with complete sale information for a current active sale. The complete sale information may include at least one of: sale price, sale volume, unit, sale amount, and a user input message. The request dispenser totals command may be a command sent from the control console to cause the dispenser controller to respond with money and volume totals for a single product dispensed from the natural gas dispenser. The request error status command may be a command sent from the control console to cause the dispenser controller to respond with complete information on current active errors within the natural gas dispenser. The data length field may indicate a number of data characters in the data field of the message. The data field may contain information pertinent to specific dispenser commands. The checksum field may be a cyclical redundancy checking (CRC) field and may contain a CRC value calculated by whichever one of the control console and the dispenser controller transmits a message including the CRC field, wherein whichever one of the control console and the dispenser controller receives the message recalculates the CRC value and compares the recalculated CRC value to the CRC value contained in the CRC field of the message, and if the CRC values do not match, the message is discarded. The network may be an RS485 network.

According to another embodiment of the present invention, a natural gas dispenser is provided comprising: a natural gas fill valve coupled to a supply line from a natural gas farm to receive natural gas, wherein the natural gas farm includes a control console for controlling operations of the natural gas farm; and a dispenser controller for controlling the natural gas fill valve. The dispenser controller is configured to communicate with the control console over a network utilizing a defined message protocol defining a packet format, the packet format comprising a sync field, an address field, a command field, data length field, data field, and a checksum field.

According to another embodiment of the present invention, a natural gas dispenser is provided comprising: a natural gas fill valve coupled to a supply line from a natural gas farm to receive natural gas, wherein the natural gas farm includes a control console for controlling operations of the natural gas farm; and a dispenser controller for controlling the natural gas fill valve, wherein the dispenser controller is configured to communicate with the control console over a selected one of two networks over which the controller may be configured to communicate, each network utilizing a different defined message protocol.

According to another embodiment of the present invention, a natural gas dispenser is provided comprising: a cabinet, a natural gas fill hose extending from the cabinet, a display disposed in the cabinet for displaying training images, and a controller coupled to the display, the controller controls the display to selectively cause the display to display the training images.

According to several embodiments, of the present invention, a fuel dispenser is provided that dispenses various types of fuel including combinations of: (a) LNG and diesel fuel; (b) LNG, diesel fuel, and DEF; (c) LNG, diesel fuel, DEF, and CNG; (d) LNG, diesel fuel, and CNG; (e) LNG and DEF; (f) LNG, DEF and CNG; (g) LNG and CNG; (h) CNG and diesel fuel; (i) CNG, diesel fuel, and DEF; (j) CNG and DEF; (k) gasoline and CNG; (I) gasoline and LNG; (m) gasoline and DEF; (n) gasoline, CNG, and diesel fuel; (o) gasoline, CNG, diesel fuel, and DEF; (p) gasoline, CNG, LNG, diesel fuel, and DEF; (q) gasoline, LNG, and diesel fuel; and (r) gasoline, LNG, diesel fuel, and DEF.

According to another embodiment of the present invention, a fuel dispenser is provided comprising: a cabinet, an LNG fill hose extending from the cabinet, an LNG fill valve disposed between the LNG fill hose and an LNG supply line, a diesel fuel fill hose extending from the cabinet, a diesel fuel fill valve disposed between the diesel fuel fill hose and a diesel fuel supply line; and a controller coupled to the LNG fill valve for selectively opening and closing the LNG fill valve to cause LNG to flow through the LNG fill hose, and coupled to the diesel fuel fill valve for selectively opening and closing the diesel fuel fill valve to cause diesel fuel to flow through the diesel fuel fill hose. The fuel dispenser may further comprise: a DEF fill hose extending from the cabinet, and a DEF fill valve disposed between the DEF fill hose and a DEF supply line, wherein the controller coupled to the DEF fill valve for selectively opening and closing the DEF fill valve to cause DEF to flow through the DEF fill hose. Additionally, the fuel dispenser may comprise: a CNG fill hose extending from the cabinet, and a CNG fill valve disposed between the CNG fill hose and a CNG supply line, wherein the controller is coupled to the CNG fill valve for selectively opening and closing the CNG fill valve to cause CNG to flow through the CNG fill hose.

According to another embodiment of the present invention, a fuel dispenser is provided comprising: a cabinet, an LNG fill hose extending from the cabinet, an LNG fill valve disposed between the LNG fill hose and an LNG supply line, a DEF fill hose extending from the cabinet, a DEF fill valve disposed between the DEF fill hose and a DEF supply line, and a controller coupled to the LNG fill valve for selectively opening and closing the LNG fill valve to cause LNG to flow through the LNG fill hose, and coupled to the DEF fill valve for selectively opening and closing the DEF fill valve to cause DEF to flow through the DEF fill hose. The fuel dispenser may further comprise: a CNG fill hose extending from the cabinet, and a CNG fill valve disposed between the CNG fill hose and a CNG supply line, wherein the controller is coupled to the CNG fill valve for selectively opening and closing the CNG fill valve to cause CNG to flow through the CNG fill hose.

According to another embodiment of the present invention, a fuel dispenser is provided comprising: a cabinet, an LNG fill hose extending from the cabinet, an LNG fill valve disposed between the LNG fill hose and an LNG supply line, a CNG fill hose extending from the cabinet, a CNG fill valve disposed between the CNG fill hose and a CNG supply line, and a controller coupled to the LNG fill valve for selectively opening and closing the LNG fill valve to cause LNG to flow through the LNG fill hose, and coupled to the CNG fill valve for selectively opening and closing the CNG fill valve to cause CNG to flow through the CNG fill hose.

According to another embodiment of the present invention, a fuel dispenser is provided comprising: a cabinet, a CNG fill hose extending from the cabinet, a CNG fill valve disposed between the CNG fill hose and a CNG supply line, a diesel fuel fill hose extending from the cabinet, a diesel fuel fill valve disposed between the diesel fuel fill hose and a diesel fuel supply line, and a controller coupled to the CNG fill valve for selectively opening and closing the CNG fill valve to cause CNG to flow through the CNG fill hose, and coupled to the diesel fuel fill valve for selectively opening and closing the diesel fuel fill valve to cause diesel fuel to flow through the diesel fuel fill hose. The fuel dispenser may further comprise: a DEF fill hose extending from the cabinet, and a DEF fill valve disposed between the DEF fill hose and a DEF supply line, wherein the controller is coupled to the DEF fill valve for selectively opening and closing the DEF fill valve to cause DEF to flow through the DEF fill hose.

According to another embodiment of the present invention, a fuel dispenser is provided comprising: a cabinet; a CNG fill hose extending from the cabinet; a CNG fill valve disposed between the CNG fill hose and a CNG supply line, a DEF fill hose extending from the cabinet; a DEF fill hose extending from the cabinet; a DEF fill valve disposed between the DEF fill hose and a DEF supply line; and a controller coupled to the CNG fill valve for selectively opening and closing the CNG fill valve to cause CNG to flow through the CNG fill hose, and coupled to the DEF fill valve for selectively opening and closing the DEF fill valve to cause DEF to flow through the DEF fill hose.

These and other features, advantages, and objects of the present invention will be further understood and appreciated by those skilled in the art by reference to the following specification, claims, and appended drawings.

### BRIEF DESCRIPTION OF THE DRAWINGS

In the drawings:

FIG. 1A is a flow diagram in schematic form of LNG hydraulic components of a dispenser according to some of the embodiments;

FIG. 1B is a flow diagram in schematic form of LNG hydraulic components of a dispenser according to some of the embodiments;

FIG. 2 is an electrical circuit diagram in block form of electrical components of an LNG dispenser according to some of the embodiments;

FIG. 3 is an elevational view of a front of an LNG dispenser in which the embodiments described herein are implemented;

FIG. 4 is an elevational view of a close-up of a portion of the front of the LNG dispenser of FIG. 3;

FIG. 5 is a perspective view of the front and side of the LNG dispenser of FIG. 3;

FIG. 6 is a hydraulic diagram in schematic form of CNG hydraulic components of a dispenser according to some of the embodiments;

FIG. 7 is an electrical circuit diagram in block form of electrical components of a CNG dispenser according to some of the embodiments;

FIG. 8 is an elevational view of a front of a CNG dispenser in which the embodiments described herein are implemented;

FIG. 9 is an elevational view of a close up of a portion of the front of the CNG dispenser of FIG. 8;

FIG. 10 is a hydraulic diagram in schematic form of CNG hydraulic components of a CNG dispenser according to an alternative embodiment;

FIG. 11 is an electrical circuit diagram in block form of electrical components of a fuel dispenser according to some of the embodiments;

FIG. 12 is a block diagram illustrating a fuel dispenser according to some of the embodiments, which combines dispensing components for dispensing any one or combination of CNG, LNG, diesel, and diesel exhaust fluid;

FIG. 13 is a perspective view of a fuel dispenser according to one of the embodiments, which combines the dispensing components for dispensing LNG, diesel, and diesel exhaust fluid;

FIGS. 14A-14H are screen shots from display 118 of a sequence of training images instructing a user how to dispense LNG; and

FIGS. 15A-15E are screen shots from display 118 of a sequence of training images instructing a user how to dispense CNG.

### DETAILED DESCRIPTION OF THE EMBODIMENTS

Reference will now be made in detail to the present preferred embodiments of the invention, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

Some of the embodiments described herein relate to fuel dispensers generally, while others relate to natural gas dispensers generally, while still yet others relate to liquid natural gas (LNG) dispensers, compressed natural gas (CNG) dispensers, diesel fuel dispensers, diesel exhaust fluid (DEF) dispensers, gasoline dispensers and various combinations thereof.

FIG. 1A is a hydraulic diagram showing the LNG hydraulic components 10 of an LNG dispenser 5. There are four lines shown that run between dispenser 5 and a natural gas farm where the LNG is stored. The first line is a supply line 12 that supplies the LNG to the dispenser. The second line is a recirculation return line 14. The third line is a vent line 16 and the fourth line is a pressure relief line 18.

Dispenser 5 further includes manual valves 20 and 22 on supply line 12 and recirculation return line 14, respectively. A mass flow meter 24 is provided in supply line 12 for measuring the mass of LNG flowing through it. As discussed further below, meter 24 is electrically coupled to a dispenser controller 110 (FIG. 2), which reads meter data during various periods of operation.

A digital temperature sensor 26 reads the temperature of the LNG and supplies the temperature data to controller 110, as described further below.

Also in supply line 12 is a first air-actuated valve or fill valve 28, which is controlled by controller 110 via an actuator valve 28a. Actuator valve 28a is an electrically-actuated pneumatic valve.

A digital pressure sensor 30 is also provided in supply line 12 proximate to vehicle fill line 32 for providing pressure readings to controller 110. At the end of vehicle fill line 32 is a nozzle 34 that has an integrated valve that opens when connected to a vehicle tank.

Recirculation return line 14 branches off of supply line 12 between temperature sensor 26 and first valve 28. A second pneumatically-actuated hydraulic valve or recirculation valve 36 is provided in recirculation return line 14 for enabling and disabling recirculation of the LNG to cool meter 24 and the lines within the dispenser before supplying the LNG to the vehicle. Recirculation valve 36 is controlled by controller 110 via an actuator valve 36a. Actuator valve 36a is an electrically-actuated pneumatic valve. A check valve 38 may also be provided in recirculation return line 14.

As noted above, the system further includes vent line 16, which branches from supply line 12 between first valve 28 and pressure sensor 30. Vent line 16 includes a third air-actuated valve or vent valve 40 for enabling and disabling venting of vapors from the vehicle. Vent valve 40 is controlled by controller 110 via an actuator valve 40a. Actuator valve 40a is an electrically-actuated pneumatic valve. The use of such a valve system allows pneumatically-actuated hydraulic valves 28, 36, and 40 to be located in the hazardous area of dispenser 5 and the electrically-actuated pneumatic actuator valves 28a, 36a, and 40a to be located in the electrical portion of a cabinet of dispenser 5, thus isolating the hazardous area from any electrical lines.

LNG dispenser 5 may further include a separate vehicle vent hose 42 having a nozzle 44 for coupling to a vehicle vent outlet. If such a vent hose 42 is provided, it is coupled to vent line 16 via a check valve 46.

Dispenser 5 further includes first, second, and third pressure relief valves 50, 52, and 54, which are coupled to pressure relief line 18. First pressure relief valve 50 is located in supply line 12 between manual valve 20 and meter 24. Second pressure relief valve 52 is located in supply line 12 between first valve 28 and the branch to vent line 16. Third pressure relief valve 54 is located in recirculation return line 14 between manual valve 22 and second valve 36. The pressure relief valves may open and vent to line 18 when the pressure in the respective lines to which they are connected exceeds a predetermined pressure of, for example, 275 psi.

One of the concerns that arises with the system shown in FIG. 1A is the presence of the recirculation return path 14 and the vent path 16 due to the fact that, when filling the vehicle tank, LNG that flows through meter 24 may be diverted through one of these other paths; meaning that the user is not getting all of the LNG that he/she is paying for. This could occur through intentional tampering with the valves 36 and 40 or through improper operation of valves 36 and 40 not closing completely. The embodiments described in more detail below can address this issue by software modifications to controller 110 that verify the integrity of the recirculation valve, vent valve, fill valve, pressure relief valve 52, and fill hose using existing hardware, thereby eliminating the need for more expensive alternative hardware solutions. Such hardware modifications are disclosed in U.S. Provisional Patent Application No. 61/790,380, entitled “IMPROVED LNG DISPENSER,” filed on Mar. 15, 2013, by Sarah Ann Lambrix et al., the entire disclosure of which is incorporated herein by reference.

Having generally described the basic structure of the LNG hydraulic components 10 of a dispenser 5, reference is made to FIG. 2 which shows the electrical components 100 of LNG dispenser 5.

As already mentioned, dispenser 5 includes dispenser controller 110, mass meter 24, temperature sensor 26, pressure sensor 30, fill valve 28, fill actuator valve 28a, recirculation valve 36, recirculation actuation valve 36a, vent valve 40, and vent actuator valve 40a. Dispenser controller 110 may comprise one or more of: microprocessors or equivalents thereof, programmed logic arrays, digital-to-analog converters, analog-to-digital converters, clocks, memory, buffers, and any other analog or digital circuitry to perform the functions described herein.

Dispenser 5 further includes a communication interface 112 that enables controller 110 to send and receive communications to and from a control console 200 that may control a natural gas farm. According to one embodiment, the communication interface 112 and control console 200 may be coupled to one another through a network and communicate with one another using a novel PLC communication protocol that is described further below.

As also shown in FIGS. 3-5, dispenser 5 may further include a ground strap 146, and the aforementioned fill hose 32, fill nozzle 34, vent hose 42, vent nozzle 44, and a user interface section 115 including a user interface keyboard 114, user interface buttons 116, a dispenser display 118, a temperature display 120, a pressure display 122, a sale/DGE display 124, one or more grade selection displays 126, one or more grade selection buttons 128, a receipt printer 130, a card reader 132, a stop button 134, and a pause/resume button 136. In general, keyboard 114 is provided so that a user may type messages that appear on dispenser display 118 to be added to the fuel sale record for use by their employer. User interface buttons 116 are preferably capacitive touch switches to reduce the risk of a spark. Buttons 116 and dispenser display 118 are multifunctional and their uses are described in part below.

Temperature display 120 is provided to display the temperature of the LNG as sensed by temperature sensor 26. This allows the user to see the temperature of the LNG fuel supplied to the vehicle tank. Similarly, pressure display 122 is provided to display the pressure of the LNG fuel as sensed by pressure sensor 30.

Sale/DGE display 124 is provided to display the sale cost (in dollars) and the diesel gallon equivalent (DGE) or mass in pounds or kilograms of the LNG mass provided to the vehicle tank as measured by mass meter 24. The DGE information may be displayed on an alternative existing display of dispenser such as displays 118, 120,122, 126, or on an additional display. Stop button 134 is provided for initiating an emergency stop. The functions of pause/resume button 136 and ground strap 146 are described below.

Dispenser 5 may further include an optional gas sensor 138, a boot nozzle sensor 140, a fresh air purge system 142, a ground confirmation circuit 144, and a compressed air hose 150.

Gas sensor 138 is provided for sensing methane gas in the environment outside the dispenser cabinet. If gas is sensed, controller 110 performs a shutdown procedure at least until such time that gas is no longer sensed. This is an improvement over prior systems where a gas sensor was coupled to a remote controller that would shut down the dispenser in a less than orderly manner.

Boot nozzle sensor 140 senses when the nozzle 34 is inserted in a nozzle boot 45 and provides this information to controller 110 for reasons described below. In essence, boot nozzle sensor 140 serves as an on/off switch. Nozzle boot 45 may also include locking mechanism for locking nozzle 34 in nozzle boot 45 when not in use.

Fresh air purge system 142 is provided in the upper chamber of the dispenser cabinet where the electrical components 100 are located to purge the air in this chamber with fresh air. This maintains a positive pressure in the electrical chamber which keeps any methane gas from reaching the electrical components.

Ground confirmation circuit 144 is coupled to ground strap 146 and is configured to confirm that the ground strap 146 has been properly grounded to the vehicle. Such a ground confirmation circuit may be a contact on the ground clamp that is coupled to controller 110 for sensing when the ground clamp is properly connected to the vehicle fuel tank. Alternatively, commercially available ground confirmation systems can be integrated for use with the dispenser.

Compressed air hose 150 is provided for the user to blow out nozzle 34 and the receptacle before fueling.

As a modification to components 10 of LNG dispenser 5, vent line 16 may be configured to couple to return line 14 such that only three lines connect to the natural gas farm. Such as system is depicted in FIG. 1B. Aside from this difference, the components of FIG. 1B are otherwise the same as those in FIG. 1A. In this embodiment, the integrity of valves 28 and 40 can be checked during the recirculation process. During recirculation, controller 110 monitors the pressure sensed by pressure sensor 30 for changes. A change in pressure would indicate that either valve 40 or valve 28 is leaking or not fully closed.

As noted above, a novel protocol is used for communications between dispenser 5 and a control console 200 that either controls or is in communication with a controller of natural gas farm. The protocol defines a message format for sending messages over a network existing not only between dispenser 5 and control console 200, but also between control console 200 and any other dispensers to which natural gas farm provides natural gas.

The message protocol used may specify a packet format. The packet format may, for example, include six fields such as a sync field, an address, a command, data length, data, and a checksum.

The sync field includes a specified sync character, which may always be the same for every message and may consist of a character that is not used in any other field with the exception of the checksum field. The sync character starts every command from the console of the filling station/natural gas farm and every response from the dispenser. When the dispenser receives the sync character, it will dump any previously received characters and prepare to receive a new command from the console.

The address field is used to identify a single fueling position on the RS485 network. The address field may also include a particular address value reserved for broadcast mode. In this case, any command can be sent to the broadcast address, and any connected fueling position will receive and execute the command. However, preferably, no fueling position will respond to a command received at the broadcast address.

The command field is used to identify a specific dispenser command. Examples of which include station status, request dispenser status, request sale status, request dispenser totals, and request error status. Descriptions of these examples are provided below. In general, messages with some of these commands are periodically initiated by the console so that the dispensers may respond and provide pertinent and timely information. The command message set defines every possible message from the console device and every possible response from the dispenser. Each command description includes the command number, command message data and response message data.

The data length field indicates the number of data characters in the data field of the message.

The data field contains information pertinent to the various defined messages. Not all messages contain a data field. When numerical data is sent in multiple bytes, the data may be sent in a fixed format that is different for each value. Within each command description, values may have defined formats which show the number of digits and the position of the decimal place.

The checksum field is a cyclical redundancy checking (CRC) field, which may, for example, be two bytes, containing a 16-bit binary value. The CRC value is calculated by the transmitting device, which appends the CRC value to the message. The receiving device recalculates the CRC value during receipt of the message, and compares the calculated value to the actual value it received in the CRC field. If the CRC values do not match, the message is discarded.

The CRC is started by first preloading a 16-bit register to all 1s. Then a process begins of applying successive 8-bit bytes of the message to the current contents of the register. Only the eight bits of data in each character are used for generating the CRC. Start and stop bits and the parity bit do not apply to the CRC.

During generation of the CRC, each 8-bit character is exclusive ORed with the register contents. Then the result is shifted in the direction of the least significant bit (LSB), with a zero filled into the most significant bit (MSB) position. The LSB is extracted and examined. If the LSB was a 1, the register is then exclusive ORed with a preset, fixed value. If the LSB was a 0, no exclusive OR takes place.

This process is repeated until eight shifts have been performed. After the last (eighth) shift, the next 8-bit character is exclusive ORed with the register's current value, and the process repeats for eight more shifts as described above. The final content of the register, after all the characters of the message have been applied, is the CRC value.

The CRC value is loaded into the checksum field low byte first then high byte. So if the calculated CRC is 0xD725, the checksum field would be 0x25, 0xD7.

Having described the fields of the message protocol, a description follows of each type of command. The station status command informs the dispenser of the status of the fuel supply. A bit of the data byte may be set to zero to tell the dispenser that fuel is not available causing the dispenser to stop an existing sale and inhibit further sales. Having that bit set to one tells the dispenser that fuel is available and allows the dispenser to initiate a sale.

The request dispenser status message causes the dispenser to provide complete status information for the dispenser. Such status messages may provide dispenser status, fuel status and fuel level percentage of the various types and grades of fuel dispensed from the dispenser, ambient temperature, product temperature, product pressure, flow rate, and density. Examples of dispenser status include: dispenser error, meter error, authorized, product request, saturated/unsaturated, recirculating, sale complete, fill valve status, recirculation valve status, vent valve status, and fuel available. Examples of fuel status includes: detector not found, detector error, calibration needed, replace sensor, low alarm active, and high alarm active.

The request sale status message causes the dispenser to provide complete sale information for the current active sale. Such information may include sale price, sale volume, unit (i.e., kg, gallon, liter), sale amount (in dollars or other currency), and a user input message that may be input by the user using keyboard 114 and dispenser display 118.

The request dispenser totals message can be used to read the money and volume totals for a single product from the dispenser. The totals for each grade may be selected through a product index that is transmitted in the response from the dispenser.

The request error status message causes the dispenser to provide complete information on current active errors within the dispenser.

FIG. 6 is a hydraulic flow diagram showing the CNG hydraulic components 210a of a dispenser 205 (FIG. 8). There are typically two to four lines that run between a dispenser and the pressure banks of a natural gas farm where the CNG is typically stored in one or three pressure banks. In typical CNG dispensers that are used with a one-pressure bank system, these lines include a vent line 252 and a supply line 216 that supplies CNG at a single high pressure to the dispenser. If the CNG dispensers are used with a three-pressure bank system, these lines include a vent line 252, and a first supply line 212 that supplies CNG at a first pressure to the dispenser, a second supply line 214 that supplies CNG at a second pressure (higher than the first pressure), and a third supply line 216 that supplies CNG at a third pressure (higher than the first and second pressures). Natural gas farms often store CNG at multiple pressures due to the cost of storing CNG at the high pressures (i.e., 3000 to 3600 psi) required for vehicles. More specifically, a natural gas farm may store CNG in a first pressure bank at 2000 psi, in a second pressure bank at 3000 psi, and in a third pressure bank at 4000 psi. When filling a vehicle tank up to 3600 psi, for example, CNG is first drawn off the first pressure bank through first supply line 212 until the vehicle tank is partially filled at 2000 psi, then CNG is drawn off the second pressure bank through second supply line 214 until the vehicle tank is partially filled at 3000 psi, and then CNG is drawn off the third pressure bank through third supply line 216 until the vehicle tank is completely filled at 3600 psi. The actual pressure at which the vehicle is filled may depend on ambient temperature as discussed further below. Because the CNG in the lower-pressure first and second pressure banks costs less to supply, the cost of filling a vehicle tank is reduced by filling the vehicle as much as possible by initially using the lower pressure first and second pressure banks to partially fill the vehicle tank.

Some of the embodiments described below provide a CNG dispenser 205 that may be configured in software to operate with either a one-pressure bank system or a three-pressure bank system. In this manner, a filling station would not have to switch CNG dispensers when changing from a one-bank system to a three-bank system or vice versa.

CNG dispenser 205 further includes manual shut-off valves 218, 220, and 222 on supply lines 212, 214, and 216, respectively. Each of supply lines 212, 214, and 216 further includes a filter 224, 226, and 228, respectively. After filtration, each of supply lines 212, 214, and 216 is split into first and second branches 212a and 212b, 214a and 214b, and 216a and 216b, where the two branches are provided for the two vehicle fill hoses 230a and 230b that are positioned on either side of dispenser 205 (see also FIG. 8). In a typical CNG dispenser 205, one fill hose 230a is configured for supplying pressure to 3000 psi and the other fill hose 230b is configured for supplying pressure to 3600 psi. In some cases, a nozzle on fill hose 230a is shaped differently than a nozzle on fill hose 230b. For example, fill hose 230a may have a nozzle that is shaped to fit a vehicle fill hole of a vehicle that runs on CNG at a pressure of 3000 psi while fill hose 230b may have a nozzle that is shaped to fit a vehicle fill hole of a vehicle that runs on CNG at a pressure of 3600 psi. This is to prevent users from inadvertently using the wrong fill hose and filling their tank to the wrong pressure. However, having different fill hoses that operate at different predetermined pressures limits the number of available fill hoses at a filling station and makes it difficult for a user to pull up to a dispenser that may be available on one side only to find out that the fill hose needed is already in use at the other side of the dispenser 205. One embodiment addresses this problem by providing a CNG dispenser 205 that allows the user to select a pressure to be delivered through any one fill hose 230a, 230b. In other words, dispenser 205 may be configured to allow selection of a “grade” of CNG having either 3000 psi or 3600 psi to be dispensed through a single fill hose 230a, 230b. In this regard, fill hose 230a may have a nozzle 232a that is shaped to fit either of the available vehicle fill hole shapes, and fill hose 230b may have a nozzle 232b that is also shaped to fit either of the available vehicle fill hole shapes. Alternatively, adapters may be attached at each nozzle.

The first branches 212a, 214a, and 216a of supply lines 212, 214, and 216 include a respective low pressure fill valve 238a, medium pressure fill valve 240a, and high pressure fill valve 242a. Likewise, the second branches 212b, 214b, and 216b of supply lines 212, 214, and 216 include a respective low pressure fill valve 238b, medium pressure fill valve 240b, and high pressure fill valve 242b. The outputs of valves 238a, 240a, and 242a are coupled to a first manifold 236a that connects first branches 212a, 214a, and 216a with a first fill line 234a, which is coupled to first fill hose 230a. The outputs of valves 238b, 240b, and 242b are coupled to a second manifold 236b that connects second branches 212b, 214b, and 216b with a second fill line 234b, which is coupled to second fill hose 230b.

Each of valves 238a, 240a, 242a, 238b, 240b, and 242b is selectively and independently opened and closed under control of a dispenser controller 110 (FIG. 7). In this manner, only one of valves 238a, 240a, and 242a is opened at any one time to supply CNG at selected pressure through first fill hose 230a. Similarly, only one of valves 238a, 240a, and 242a is opened at any one time to supply CNG at selected pressure through second fill hose 230a.

Valves 238a, 240a, 242a, 238b, 240b, and 242b may be pneumatically-actuated hydraulic valves, which are controlled by controller 110 via respective actuator valves 239a, 241a, 243a, 239b, 241b, and 243b (FIG. 7). These actuator valves 239a, 241a, 243a, 239b, 241b, and 243b may be electrically-actuated pneumatic valves. The use of such a valve system allows the pneumatically-actuated hydraulic valves 238a, 240a, 242a, 238b, 240b, and 242b to be located in the hazardous area of dispenser 205 and the electrically-actuated pneumatic actuator valves 239a, 241a, 243a, 239b, 241b, and 243b to be located in the electrical portion of a cabinet 206 (FIG. 8) of dispenser 205, thus isolating the hazardous area from any electrical lines. Alternatively, fill valves 238a, 240a, 242a, 238b, 240b, and 242b may be electrically-operated explosion proof valves thereby eliminating the need for the electrically-actuated pneumatic actuator valves 239a, 241a, 243a, 239b, 241b, and 243b.

A first meter 244a is provided in fill line 234a for measuring the CNG flowing through it. A second meter 244b is provided in fill line 234b for measuring the CNG flowing through it. As discussed further below, meters 244a and 244b are electrically coupled to dispenser controller 110 (FIG. 7), which reads meter data during various periods of operation.

A first digital pressure sensor 246a is also provided in first fill line 234a proximate first vehicle fill hose 230a for providing pressure readings to controller 110. When filling a vehicle tank using first fill hose 230a, controller 110 may first reads a selected pressure as determined by which grade the user selected by pressing a grade select button 128 (if provided) corresponding to the desired pressure. Controller 110 then opens first low pressure fill valve 238a while keeping closed first medium pressure valve 240a and first high pressure valve 242a such that CNG from the low pressure bank supplied via first supply line 212 is dispensed to the vehicle tank. Controller 110 monitors the pressure readings from first digital pressure sensor 246a, which correspond to the pressure in the vehicle tank when filling the vehicle tank. Thus, controller 110 may monitor the progress of the filling of the vehicle tank and when the pressure reaches a first pressure level corresponding to the low pressure level supplied from first supply line 212 (i.e., 2000 psi), controller 110 may close first low pressure fill valve 238a and open first medium pressure valve 240a while keeping closed first high pressure valve 242a such that CNG from the medium pressure bank supplied via second supply line 214 is dispensed to the vehicle tank. Then, when the pressure reaches a second pressure level corresponding to the medium pressure level supplied from second supply line 214 (i.e., 3000 psi), controller 110 may close first medium pressure fill valve 240a. If the pressure selected by the user is 3000 psi, the sale is completed. On the other hand, if the pressure selected by the user is 3600 psi, controller 110 opens first high pressure valve 242a while keeping closed first low pressure valve 238a and first medium pressure valve 240a such that CNG from the high pressure bank supplied via third supply line 216 is dispensed to the vehicle tank. Once the pressure reaches a third pressure level corresponding to the user-selected pressure, controller 110 closes first high pressure valve 242a and completes the sale.

It will be apparent to those skilled in the art that the second branches with associated fill valves 238b, 240b, and 242b that are used to feed second fill line 234b and fill hose 230b may be operated in the same manner.

A digital temperature sensor 270 (FIG. 7) reads the ambient temperature of the outside air surrounding dispenser 205 and supplies the temperature data to controller 110. Controller 110 may use the ambient temperature reading to adjust the pressure to which the vehicle tank is to be filled. For example, if the proper pressure for a vehicle is 3600 psi at 60° F., controller 110 reduces the pressure at colder temperatures such that the CNG does not over-pressurize as it warms up. Likewise, controller 110 increases the pressure at warmer temperatures. Controller 110 may display the ambient temperature on ambient temperature display 120.

As noted above, the system further includes vent line 252 (FIG. 6), which connects to vent hoses 250a and 250b extending from respective nozzles 232a and 232b via check valves 254a and 254b.

Dispenser 205 further includes a pressure relief valve 256, which is coupled to pressure relief lines 235a and 235b branching off of fill lines 234a and 234b, respectively. Pressure relief valve 256 may open and vent to vent line 252 when the pressure in either of pressure relief lines 235a and 235b exceeds a predetermined pressure of, for example, 4500 psi. Pressure relief lines 235a and 235b may include check valves 258a and 258b, respectively. A manually operated bleed valve 260 may be connected between pressure relief lines 235a and 235b and vent line 252 to bleed off excess pressure in fill lines 234a and 234b to vent line 252.

Dispenser 205 may further include analog pressure gauges 248a and 248b for displaying pressure in fill lines 234a and 234b, respectively. Such gauges 248a, 248b provide a way to confirm the accuracy and calibration of the digital pressure sensors 246a and 246b.

Having generally described the basic structure of the CNG hydraulic components 210a of a dispenser 205, reference is made to FIG. 7, which shows the electrical components 207 of dispenser 205.

As already mentioned, dispenser 205 includes dispenser controller 110; meters 244a and 244b; temperature sensor 270; pressure sensors 246a and 246b; fill valves 238a, 240a, 242a, 238b, 240b, and 242b; and optional actuator valves 239a, 241a, 243a, 239b, 241b, and 243b. Dispenser controller 110 may comprise one or more of: microprocessors or equivalents thereof, programmed logic arrays, digital-to-analog converters, analog-to-digital converters, clocks, memory, buffers, and any other analog or digital circuitry to perform the functions described herein.

Dispenser 205 further includes a communication interface 112 that enables controller 110 to send and receive communications to and from a control console 200 that may control the pressure banks of a natural gas farm. According to one embodiment, the communication interface 112 and control console 200 may be coupled to one another through a network and communicate with one another using a PLC communication protocol.

As also shown in FIGS. 8 and 9, dispenser 205 may further include the aforementioned fill hoses 230a and 230b, fill nozzles 232a and 232b, and a user interface section 265 including a user interface keyboard or numeric keypad 114, user interface buttons 116, a dispenser display 118, an ambient temperature display 120, a pressure display 122, a sale/GGE display 124, one or more optional grade selection displays 126, one or more grade selection buttons 128, a receipt printer 130, a card reader 132, and a stop button 134. User interface buttons 116 are preferably capacitive touch switches to reduce the risk of a spark. Buttons 116 and dispenser display 118 are multifunctional. A duplicate user interface section 265 may be provided on the other side of dispenser 205 for use by a user operating fill hose 230b.

Controller 110 may control display 118 to show graphic displays. One such graphic display is a fill indicator bar, which displays the relative levels at which the vehicle tank is filled based upon the sensed pressure relative to the desired pressure.

Pressure display 122 is provided to display the pressure of the CNG fuel as sensed by a corresponding pressure sensor 246a or 246b.

Sale/GGE display 124 is provided to display the sale cost (in dollars) and the gasoline gallon equivalent (GGE) or mass in pounds or kilograms of the CNG dispensed to the vehicle tank as measured by a corresponding meter 244a or 244b. The GGE information may be displayed on an alternate existing display of dispenser such as displays 118, 120,122, and 126 or on an additional display. Stop button 134 is provided for initiating an emergency stop.

Dispenser 205 may further include a gas sensor 138, a boot nozzle sensor 140, and a fresh air purge system 142.

Gas sensor 138 is provided for sensing methane gas in the environment outside the dispenser cabinet. If gas is sensed, controller 110 performs a shutdown procedure at least until such time that gas is no longer sensed. This is an improvement over prior systems where a gas sensor was coupled to a remote controller that would shut down the dispenser in a less than orderly manner.

Boot nozzle sensor 140 senses when the nozzle 232a, 232b is inserted in a nozzle boot 274 and provides this information to controller 110. In essence, boot nozzle sensor 140 serves as an on/off switch. Nozzle boot 274 may also include a locking mechanism for locking nozzle 232a or 232b in nozzle boot 274 when the dispenser is not operational.

Fresh air purge system 142 is provided in the upper chamber of the dispenser cabinet where the electrical components 207 are located to purge the air in this chamber with fresh air. This maintains a positive pressure in the electrical chamber, which keeps any methane gas from reaching the electrical components.

Components 210b of a second embodiment of a CNG dispenser are shown in FIG. 10, which is designed for a one-pressure bank system where a vent line 252 and only a high pressure supply line 216 are provided. In this embodiment, some of the components are eliminated and the remaining components are the same as those mentioned above. In essence, the second embodiment eliminates supply lines 212 and 214; main shut off valves 218 and 220; filters 224 and 226; fill valves 238a, 238b, 240a, and 240b; and manifolds 236a and 236b.

In operation, controller 110 simply fills from a high pressure supply line (i.e., 4000 psi) by opening valve 242a or 242b depending on which fill hose 230a or 230b is being used, and keeping the valve open while monitoring the pressure reading from the corresponding pressure sensor 246a or 246b until the selected pressure is reached at which point controller 110 closes valve 242a or 242b and completes the sale.

Although the second embodiment does not provide the advantage of being capable of being used with a three-bank system, it still provides all of the other novel features and thus benefits from their advantages.

Although both of the embodiments above show CNG dispensers with two CNG fill hoses 232a, 232b, the various aspects of the present invention may be implemented in dispensers having one CNG fill hose or dispensers having more than two CNG fill hoses 232a, 232b.

According to several embodiments of the present invention, a fuel dispenser is provided that dispenses various types of fuel including combinations of: (a) LNG and diesel fuel; (b) LNG, diesel fuel, and DEF; (c) LNG, diesel fuel, DEF, and CNG; (d) LNG, diesel fuel, and CNG; (e) LNG and DEF; (f) LNG, DEF and CNG; (g) LNG and CNG; (h) CNG and diesel fuel; (i) CNG, diesel fuel, and DEF; and (j) CNG and DEF. Each of these combinations corresponds to one of the several embodiments described further below. Other embodiments are possible that add gasoline to any of the above embodiments or that substitute gasoline for one of the above fuel types. Thus, additional embodiments may include combinations of: (k) gasoline and CNG; (I) gasoline and LNG; (m) gasoline and DEF; (n) gasoline, CNG, and diesel fuel; (o) gasoline, CNG, diesel fuel, and DEF; (p) gasoline, CNG, LNG, diesel fuel, and DEF; (q) gasoline, LNG, and diesel fuel; and (r) gasoline, LNG, diesel fuel, and DEF.

Some vehicles, particularly long-haul trucks, utilize various combinations of fuels and fluids. By providing all of the fuel types through a single dispenser, users having vehicles that require various combinations of these fuels and fluids may acquire them all at one location within the filling station without have to fill up with one fluid only to have to pull ahead and fill with another fluid as is the current situation at filling stations. This not only is a convenience for the user, but it also reduces traffic within the filling station while eliminating the need for purchasing separate dispensers with some redundant components.

Further, having one dispenser allows the user to acquire all of the fuels and fluids in a single sales transaction rather than in separate transactions for each type of fuel or fluid. Again, this not only is a convenience for the user, but it also benefits the filling station by having less sales records to process.

According to embodiment (a), a fuel dispenser is provided comprising: a cabinet, an LNG fill hose extending from the cabinet, an LNG fill valve disposed between the LNG fill hose and an LNG supply line, a diesel fuel fill hose extending from the cabinet, a diesel fuel fill valve disposed between the diesel fuel fill hose and a diesel fuel supply line, and a controller coupled to the LNG fill valve for selectively opening and closing the LNG fill valve to cause LNG to flow through the LNG fill hose, and coupled to the diesel fuel fill valve for selectively opening and closing the diesel fuel fill valve to cause diesel fuel to flow through the diesel fuel fill hose.

According to embodiment (b), the fuel dispenser as described for embodiment (a) may further comprise: a DEF fill hose extending from the cabinet, and a DEF fill valve disposed between the DEF fill hose and a DEF supply line, wherein the controller is coupled to the DEF fill valve for selectively opening and closing the DEF fill valve to cause DEF to flow through the DEF fill hose. A dispenser 300a for dispensing LNG, diesel fuel, and DEF is shown in FIG. 13 and described further below.

According to embodiment (c), the fuel dispenser as described for embodiment (b) may further comprise: CNG fill hose extending from the cabinet and a CNG fill valve disposed between the CNG fill hose and a CNG supply line, wherein the controller coupled to the CNG fill valve for selectively opening and closing the CNG fill valve to cause CNG to flow through the CNG fill hose.

According to embodiment (d), the fuel dispenser as described for embodiment (a) may further comprise: CNG fill hose extending from the cabinet and a CNG fill valve disposed between the CNG fill hose and a CNG supply line, wherein the controller is coupled to the CNG fill valve for selectively opening and closing the CNG fill valve to cause CNG to flow through the CNG fill hose.

According to embodiment (e), a fuel dispenser is provided comprising: a cabinet, an LNG fill hose extending from the cabinet, an LNG fill valve disposed between the LNG fill hose and an LNG supply line, a DEF fill hose extending from the cabinet, a DEF fill valve disposed between the DEF fill hose and a DEF supply line, and a controller coupled to the LNG fill valve for selectively opening and closing the LNG fill valve to cause LNG to flow through the LNG fill hose, and coupled to the DEF fill valve for selectively opening and closing the DEF fill valve to cause DEF to flow through the DEF fill hose.

According to embodiment (f), the fuel dispenser as described for embodiment (e) may further comprise: a CNG fill hose extending from the cabinet, and a CNG fill valve disposed between the CNG fill hose and a CNG supply line, wherein the controller coupled to the CNG fill valve for selectively opening and closing the CNG fill valve to cause CNG to flow through the CNG fill hose.

According to embodiment (g), a fuel dispenser is provided comprising: a cabinet, an LNG fill hose extending from the cabinet, an LNG fill valve disposed between the LNG fill hose and an LNG supply line, a CNG fill hose extending from the cabinet, a CNG fill valve disposed between the CNG fill hose and a CNG supply line, and a controller coupled to the LNG fill valve for selectively opening and closing the LNG fill valve to cause LNG to flow through the LNG fill hose, and coupled to the CNG fill valve for selectively opening and closing the CNG fill valve to cause CNG to flow through the CNG fill hose.

According to embodiment (h), a fuel dispenser is provided comprising: a cabinet, a CNG fill hose extending from the cabinet, a CNG fill valve disposed between the CNG fill hose and a CNG supply line, a diesel fuel fill hose extending from the cabinet, a diesel fuel fill valve disposed between the diesel fuel fill hose and a diesel fuel supply line, and a controller coupled to the CNG fill valve for selectively opening and closing the CNG fill valve to cause CNG to flow through the CNG fill hose, and coupled to the diesel fuel fill valve for selectively opening and closing the diesel fuel fill valve to cause diesel fuel to flow through the diesel fuel fill hose.

According to embodiment (i), the fuel dispenser as described for embodiment (h) may further comprise: a DEF fill hose extending from the cabinet, and a DEF fill valve disposed between the DEF fill hose and a DEF supply line, wherein the controller is coupled to the DEF fill valve for selectively opening and closing the DEF fill valve to cause DEF to flow through the DEF fill hose.

According to embodiment (j), a fuel dispenser is provided comprising: a cabinet; a CNG fill hose extending from the cabinet; a CNG fill valve disposed between the CNG fill hose and a CNG supply line; a DEF fill hose extending from the cabinet; a DEF fill valve disposed between the DEF fill hose and a DEF supply line; and a controller coupled to the CNG fill valve for selectively opening and closing the CNG fill valve to cause CNG to flow through the CNG fill hose, and coupled to the DEF fill valve for selectively opening and closing the DEF fill valve to cause DEF to flow through the DEF fill hose.

FIGS. 11 and 12 shows embodiment (c) above, which pertains to a fuel dispenser that dispenses all the aforementioned types of fuel including LNG, diesel fuel, DEF, and CNG. Because all of the other embodiments (a), (b), and (d)-(j) are subcombinations of embodiment (c), all of the features of those other embodiments are also represented in FIGS. 11 and 12.

As shown in FIG. 12, fuel dispenser 300 includes a cabinet 305, an LNG fill hose 32, a diesel fuel fill hose 310, a DEF fill hose 312, and CNG fill hoses 230a and 230b all extending from cabinet 305. As explained further below, to dispense LNG and CNG, dispenser 300 includes LNG hydraulic components 10, LNG electrical components 100, CNG hydraulic components 210, and CNG electrical components 207 such as those described above. Accordingly, dispenser 300 includes an LNG fill valve 28 disposed between LNG fill hose 32 and LNG supply line 12 and CNG fill valves 238a, 240a, 242a, 238b, 240b, and 242b disposed between CNG fill hoses 230a and 230b and CNG supply lines 212, 214, and 216. Dispenser 300 further includes a diesel fuel fill valve 314 disposed between diesel fuel fill hose 310 and a diesel fuel supply line 316, and a DEF fill valve 318 disposed between DEF fill hose 312 and a DEF supply line 320. Gasoline fill hoses and fill valves may also be provided.

Dispenser 300 includes a dispenser controller such as controller 110 that controls dispensing of all of the fluids dispensed from dispenser 300. Accordingly, controller 110 is coupled to LNG fill valve 28 for selectively opening and closing LNG fill valve 28 to cause LNG to flow through LNG fill hose 32, and is coupled to diesel fuel fill valve 314 for selectively opening and closing diesel fuel fill valve 314 to cause diesel fuel to be dispensed through diesel fuel fill hose 310. Further, controller 110 is coupled to DEF fill valve 318 for selectively opening and closing DEF fill valve 318 to cause DEF to flow through DEF fill hose 312, and is coupled to CNG fill actuator valves 239a, 241a, 243a, 239b, 241b, and 243b for selectively opening and closing CNG fill valves 238a, 240a, 242a, 238b, 240b, and 242b to cause CNG to flow through CNG fill hoses 230a and 230b. Controller 110 may further be coupled to a gasoline fill valve (not shown) for selectively opening and closing the gasoline fill valve to cause gasoline to flow through a gasoline fill hose.

Dispenser 300 may also include one or more of LNG meter 24, CNG meters 244a and 244b, a diesel fuel meter 322, a DEF meter 324, and a gasoline meter (not shown) for metering the amounts of these fuels and fluids delivered.

Dispenser 300 would also include those electrical components 301 shown in FIG. 11 as needed to properly dispense the various types of fuel. Accordingly, dispenser controller 110 may also operate to monitor the various parameters such as readings from temperature sensors, pressure sensors, and meters as needed to properly dispense the various types of fuel and create sales records.

Dispenser 300 also includes a user interface section 330 for receiving information from a user and displaying information to the user. User interface section 330 interacts with controller 110. User interface section 330 comprises at least one of: user interface keyboard 114, user interface buttons 116, dispenser display 118, temperature display 120, pressure display 122, sale/units delivered display (the units delivered display may display DGE for LNG and GGE for CNG) 124, fuel/grade selection displays 126, fuel/grade selection buttons 128, receipt printer 130, card reader 132, stop button 134, pause/resume button 136, and speaker (not shown).

Dispenser 300 may use the protocol disclosed above to communicate with control console 200 that controls delivery of the various fuels and fluids to dispenser 300.

Because LNG is delivered at such a low temperature (i.e., below about −220° F.), the temperature in the portion of cabinet 305 that houses the LNG hydraulic components 10 is very low. This low temperature could potentially adversely affect (or even freeze) the diesel fuel line within dispenser 300. Accordingly, LNG hydraulic components 10 may be segregated to one side of cabinet 305 and thermally insulated from the remaining hydraulic components for diesel, CNG, and DEF. Further, the DEF hydraulic components 335 are typically heated. Accordingly, DEF hydraulic components 335 may be positioned in a common insulated chamber of cabinet 305 as diesel hydraulic components 340 and CNG hydraulic components 210.

FIG. 13 shows a dispenser 300a constructed in accordance with embodiment (b), which dispenses LNG, diesel fuel, and DEF. Accordingly, dispenser 300a includes the hydraulic components 10 shown in FIG. 1 for dispensing LNG and the electrical and hydraulic components shown in FIG. 11 for dispensing LNG, diesel fuel, and DEF. As depicted in FIG. 13, dispenser 300a includes an LNG fill hose 32, a grounding strap 146, and a diesel fuel fill hose 310. A DEF fill hose 312 is present in dispenser 300a (but not visible in FIG. 13) and is retractably disposed on a hose reel inside of a heated side cabinet 321. A door 321a is provided on the front of side cabinet 321 to allow a user to access DEF fill hose 312. Although not shown in FIG. 13, a vent hose may also be provided. Dispenser 300a may include an internal insulation layer to thermally insulate the diesel fuel hydraulic components 340 from the LNG hydraulic components 10. Air gaps may be provided around the portion of dispenser 300a that houses the electrical components to lessen the possibility of gas fumes entering that portion of the dispenser.

Dispenser 300a may have similar fill hoses and a user interface on the other side of the dispenser. Alternatively, a second diesel fuel fill hose (and optionally a second DEF fill hose) may be provided on the other side of dispenser 300a for satellite operation by another dispenser on an adjunct service island. Such a satellite configuration allows a truck operator to pull between two adjacent service islands such that dispensers 300a are located on either side of the truck. The truck operator may fill the tanks on one side of the truck with LNG, diesel fuel, and DEF, for example, and simultaneously fill a tank on the other side of the truck with diesel fuel using the satellite diesel fill hose on the backside of the adjacent dispenser. The fueling with the satellite fill hose may be controlled by the one dispenser 300a so that such fuel is included in a single sales transaction.

Controller 110 may selectively control display 118 so as to cause it to display a sequence of training images that provide instructions on how to pump a selected type of fuel. Controller 110 may require the training images to be displayed prior to permitting fuel to be dispensed. The sequence of images may be a slide show or a video clip. The training images may be interactive such that controller 110 occasionally pauses the sequence of training images and prompts a user to activate at least one user interface button 116 before continuing the sequence of training images. If a speaker is provided in the dispenser, an audio track corresponding to the training images may be played over the speaker.

FIGS. 14A-14H show examples of screen shots of training images that may be displayed on a display of an LNG dispenser or on a display of a multi-fuel dispenser that dispenses LNG.

FIGS. 15A-15E show examples of screen shots of training images that may be displayed on a display of a CNG dispenser or on a display of a multi-fuel dispenser that dispenses CNG.

The above description is considered that of the preferred embodiments only.

Modifications of the invention will occur to those skilled in the art and to those who make or use the invention. Therefore, it is understood that the embodiments shown in the drawings and described above are merely for illustrative purposes and not intended to limit the scope of the invention, which is defined by the claims as interpreted according to the principles of patent law, including the doctrine of equivalents.

What is claimed is:

1. A natural gas dispenser comprising:
a cabinet;
a natural gas fill hose extending from said cabinet;
a display disposed in said cabinet for displaying training images; and
a controller coupled to said display, said controller controls said display to selectively cause said display to display the training images.

2. The natural gas dispenser of claim 1, wherein said controller controls said display to selectively cause said display to display a sequence of the training images as a slide show.

3. The natural gas dispenser of claim 1 and further comprising:
at least one user interface button disposed on said cabinet and coupled to said controller,
wherein said controller interactively controls said display to selectively cause said display to display a sequence of the training images while occasionally pausing the sequence of training images and prompting a user to activate said at least one user interface button before continuing the sequence of training images.

4. The natural gas dispenser of claim 1, wherein said controller controls said display to selectively cause said display to display the training images in the form of a video clip.

5. The natural gas dispenser of claim 1 and further comprising:
a speaker disposed in said cabinet for playing an audio track corresponding to the training images.

6. A fuel dispenser comprising:
a cabinet;
an LNG fill hose extending from said cabinet;
an LNG fill valve disposed between said LNG fill hose and an LNG supply line;
a diesel fuel fill hose extending from said cabinet;
a diesel fuel fill valve disposed between said diesel fuel fill hose and a diesel fuel supply line; and
a controller coupled to said LNG fill valve for selectively opening and closing said LNG fill valve to cause LNG to flow through said LNG fill hose, and coupled to said diesel fuel fill valve for selectively opening and closing said diesel fuel fill valve to cause diesel fuel to flow through said diesel fuel fill hose.

7. The fuel dispenser of claim 6 and further comprising:
a DEF fill hose extending from said cabinet; and
a DEF fill valve disposed between said DEF fill hose and a DEF supply line,
wherein said controller coupled to said DEF fill valve for selectively opening and closing said DEF fill valve to cause DEF to flow through said DEF fill hose.

8. The fuel dispenser of claim 7, wherein said controller controls sales transactions, wherein said controller allows a user to dispense more than one fuel type in a single sales transaction.

9. The fuel dispenser of claim 7, wherein said LNG fill valve is thermally insulated from said diesel fuel fill valve and said DEF fill valve.

10. The fuel dispenser of claim 7 and further comprising:
a CNG fill hose extending from said cabinet; and
a CNG fill valve disposed between said CNG fill hose and a CNG supply line,
wherein said controller is coupled to said CNG fill valve for selectively opening and closing said CNG fill valve to cause CNG to flow through said CNG fill hose.

11. The fuel dispenser of claim 6 and further comprising:
a CNG fill hose extending from said cabinet; and
a CNG fill valve disposed between said CNG fill hose and a CNG supply line,
wherein said controller is coupled to said CNG fill valve for selectively opening and closing said CNG fill valve to cause CNG to flow through said CNG fill hose.

12. The fuel dispenser of claim 6 and further comprising:
a user interface section for receiving information from a user and displaying information to the user, wherein said user interface section interacts with said controller.

13. The fuel dispenser of claim 12, wherein said user interface section comprises at least one of: a user interface keyboard; user interface buttons; a dispenser display; a temperature display; a pressure display; a sale/gallons/DGE/GGE/Pounds/Kilograms display; grade selection displays; grade selection buttons; a receipt printer; a card reader; a stop button; and a pause/resume button.

14. The fuel dispenser of claim 6, wherein said controller controls sales transactions, wherein said controller allows a user to dispense more than one fuel type in a single sales transaction.

15. The fuel dispenser of claim 6, wherein said LNG fill valve is thermally insulated from said diesel fuel fill valve and said DEF fill valve.

16. The fuel dispenser of claim 6 and further comprising:
a display disposed in said cabinet for displaying training images corresponding to a selected fuel type,
wherein said controller is coupled to said display, said controller controls said display to selectively cause said display to display the training images.

17. The fuel dispenser of claim 6, wherein said fill valves are coupled to supply lines from a fluid farm to receive fluid, wherein the fluid farm includes a control console for controlling operations of the fluid farm, and
wherein said controller is configured to communicate with the control console over a network utilizing a defined message protocol defining a packet format, the packet format comprising a sync field, an address field, a command field, data length field, data field, and a checksum field.

18. A fuel dispenser comprising:
a cabinet;
an LNG fill hose extending from said cabinet;
an LNG fill valve disposed between said LNG fill hose and an LNG supply line;
a DEF fill hose extending from said cabinet;
a DEF fill valve disposed between said DEF fill hose and a DEF supply line; and
a controller coupled to said LNG fill valve for selectively opening and closing said LNG fill valve to cause LNG to flow through said LNG fill hose, and coupled to said DEF fill valve for selectively opening and closing said DEF fill valve to cause DEF to flow through said DEF fill hose.

19. The fuel dispenser of claim 18 and further comprising:
a CNG fill hose extending from said cabinet; and
a CNG fill valve disposed between said CNG fill hose and a CNG supply line,
wherein said controller coupled to said CNG fill valve for selectively opening and closing said CNG fill valve to cause CNG to flow through said CNG fill hose.

20. The fuel dispenser of claim 18, wherein said controller controls sales transactions, wherein said controller allows a user to dispense more than one fuel type in a single sales transaction.

21. A fuel dispenser comprising:
a cabinet;
an LNG fill hose extending from said cabinet;
an LNG fill valve disposed between said LNG fill hose and an LNG supply line;
a CNG fill hose extending from said cabinet;
a CNG fill valve disposed between said CNG fill hose and a CNG supply line; and
a controller coupled to said LNG fill valve for selectively opening and closing said LNG fill valve to cause LNG to flow through said LNG fill hose, and coupled to said CNG fill valve for selectively opening and closing said CNG fill valve to cause CNG to flow through said CNG fill hose.

22. The fuel dispenser of claim 21, wherein said controller controls sales transactions, wherein said controller allows a user to dispense more than one fuel type in a single sales transaction.

23. A fuel dispenser comprising:
a cabinet;
a CNG fill hose extending from said cabinet;
a CNG fill valve disposed between said CNG fill hose and a CNG supply line;
a diesel fuel fill hose extending from said cabinet;
a diesel fuel fill valve disposed between said diesel fuel fill hose and a diesel fuel supply line; and
a controller coupled to said CNG fill valve for selectively opening and closing said CNG fill valve to cause CNG to flow through said CNG fill hose, and coupled to said diesel fuel fill valve for selectively opening and closing said diesel fuel fill valve to cause diesel fuel to flow through said diesel fuel fill hose.

24. The fuel dispenser of claim 23 and further comprising:
a DEF fill hose extending from said cabinet; and
a DEF fill valve disposed between said DEF fill hose and a DEF supply line,
wherein said controller coupled to said DEF fill valve for selectively opening and closing said DEF fill valve to cause DEF to flow through said DEF fill hose.

25. The fuel dispenser of claim 23, wherein said controller controls sales transactions, wherein said controller allows a user to dispense more than one fuel type in a single sales transaction.

26. A fuel dispenser comprising:
a cabinet;
a CNG fill hose extending from said cabinet;
a CNG fill valve disposed between said CNG fill hose and a CNG supply line;
a DEF fill hose extending from said cabinet;
a DEF fill valve disposed between said DEF fill hose and a DEF supply line; and
a controller coupled to said CNG fill valve for selectively opening and closing said CNG fill valve to cause CNG to flow through said CNG fill hose, and coupled to said DEF fill valve for selectively opening and closing said DEF fill valve to cause DEF to flow through said DEF fill hose.

27. The fuel dispenser of claim 26, wherein said controller controls sales transactions, wherein said controller allows a user to dispense more than one fuel type in a single sales transaction.
